(19) United States
(12) Patent Application Publication
(10) Pub. No.: US 2023/0415278 A1
(43) Pub. Date: Dec. 28, 2023

(54) WELDERS' CART AND METHOD

(71) Applicant: RONALD E. GREEN, BUHL, ID (US)

(72) Inventor: RONALD E. GREEN, BUHL, ID (US)

(21) Appl. No.: 18/213,877

(22) Filed: Jun. 25, 2023

Related U.S. Application Data
(60) Provisional application No. 63/355,434, filed on Jun. 24, 2022.

(51) Int. Cl. B23K 37/02

(52) U.S. Cl. CPC B23K 37/0294; B23K 37/0258; B23K 37/0252; B23K 37/0211

(57) ABSTRACT

A self-contained track or wheeled welders' cart may be driven at a wheel or set of wheels and/or at a track or set of tracks by hydraulic wheel drive motor(s). The hydraulic wheel/track motor(s) may in turn be driven by high-pressure hydraulic oil provided by an electric-hydraulic pump motor driven by electricity that is generated on the cart by an internal combustion engine. The powered cart may be moved forward and backward via, for example, a radio or other non-wired-signal remote controller in communication with a drive system for the cart's electric-hydraulic driven tracks(s) and/or wheels(s) on the cart. Also, the remote controller may be in communication with a rack and pinion type steering mechanism, for example. Electricity created on the cart may be used also for a portable welding system carried on the cart.

This application claims benefit of Provisional Application Ser. No. 63/355,434 filed Jun. 24, 2022, and entitled “Welders' Cart and Method”, the entire disclosure of which is incorporated herein by this reference.

### BACKGROUND OF THE DISCLOSED TECHNOLOGY

### Field of the Disclosed Technology

This invention relates generally to welding for metal fabrication, especially in the construction industry. Of particular relevance is the on-site creation and installation of metal pipe and rod fences, especially those constructed with portable welding machine set-ups, these welding set-ups being typically placed in and secured to pick-up truck beds, or to trailers towed by pick-up trucks.

### Related Art

U.S. Pat. No. 6,596,972 (DiNovo et al.) describes a portable welding hand truck dolly with accessory supports.
U.S. Pat. Nos. 6,989,509 and 7,098,424 (Silvestro) describe a portable combined welder, generator and compressor unit powered by an engine.
U.S. Pat. No. 7,703,777 (Horn, Jr.) describes a pushcart with an air compressor and electrical generator. The cart may have a welder assembly instead of the compressor and may also be motorized.
U.S. Pat. No. 8,653,416 (Laitala) describes a portable welder powered by an engine, and a pair of both leading wheels and trailing wheels, the two wheel pairs having different resiliency.

In the industrial arts/non-patent documents, there are:
1. an un-powered manual-push mobile welding cart by Miller-Bobcat™/Trail-blazer™ (#300913);
2. a battery-powered hand-steerable load cart by Vestil (#NE-Cart-1 and #OROAD-400);
3. a powered steerable load cart under cord control by DJ Products, Inc.;
4. a customizable powered robotic cart (#4WD IG42-DM-E) by superdroidrobots.com; and another customizable powered robotic cart from the Rait brothers posted by sparkfun.com.

### SUMMARY OF THE DISCLOSED TECHNOLOGY

The disclosed technology comprises a wheeled cart that may be driven, for example, at any wheel or set of wheels or tracks by, for example, a hydraulic pump motor and wheel/track drive motor(s). The hydraulic pump motor may in turn be driven by electricity, which electricity is generated on the cart, for example, by an internal combustion engine, the engine being powered, for example, by petroleum liquid fuel stored in a tank on the cart. Natural gas and LPG may also be suitable fuels. The powered cart may be moved forward and backward and at adjustable rates via, for example, a radio remote controller in communication with a gearbox and possible wheel speed-control on the cart. Also, the radio controller may be in communication with a steering assembly, for example, like a rack and pinion steering mechanism connected to the cart's front and/or back wheel(s). In another steering embodiment, the radio controller may be in communication with, for example, speed-control for an independent plurality of the cart's electric/hydraulic wheels. These ways, the cart may be self-contained in terms of energy and mobility required for its work functions. In preferred embodiments, the controller of the cart is not connected to the cart by any electrical or electronic cable or wire(s). For example, there is no electric or electronic control cable or wire between the hand-held radio or other signal-transmitting controller and the cart or any element of the cart. Therefore, in preferred embodiments, control of the cart may be described as remote control without any connection between the controller and the cart other than radio or other non-wired signals.

Electricity created on the cart may be used also for a carried conventional portable welding system. Cords and hoses for the welding system, as well as welders' tools and supplies, may also be provided in storage spaces on the cart or towed behind the cart, making it a powered-mobile, self-contained welders' cart.

As discussed above, because the subject welders' cart may be made to be remotely drivable and steerable via, for example, a radio remote controller, the cart may be conveniently and quickly loaded on a vehicle such as a pickup truck or a trailer towed by a pickup or other truck or utility vehicle. Then, after driving the truck/trailer loaded with the welder's cart to the worksite, the cart may be conveniently unloaded off the truck/trailer via a ramp and put to use at the worksite, even remote and/or difficult, off-road worksites. The loading and unloading of the preferred cart are particularly convenient due to the cart's remote control and due to the cart's rugged, preferably all-terrain treads or tires and drive systems. This way, the user need not manually maneuver, push, or pull, or even touch the cart during the loading and unloading steps. Once unloaded at the worksite, the cart and its portable welder system are especially beneficial to create or repair horizontally elongated structures that require welding along the length of the structure, for example, for long lengths of remote, on-site welded fence. When working on such elongated structures, progress of fence construction/repair typically extends past the length of the welding system's attached cords/hoses lengths, for example, so that the welder must advance in many increments along the length of the fence line as he/she applies the welding system at many sequential locations along the fence line. For example, a fence line may be many yards, fractions of a mile, or miles long, and advancing along these distances several yards at a time can be very time consuming and tedious if the welder's vehicle is being entered, driven, and stopped again each time advancement is required. On the other hand, by using the disclosed apparatus and methods, the welder operator does not have to stop the welding work, move the welding system that is secured to the truck or trailer by driving the truck to the next location that may be, for example, just 20-60 feet away, and start welding again. In other words, in order to apply the welding system at another location along the fence line whenever progress of the fence construction, for example, extends past the length of the welding system's attached cords and hoses lengths, the welder operator simply remote-control drives the cart to the new location along the fence line. Also, this way when the day's work is done, the operator may remote-control drive the cart and its equipment back from the then current fence construction site and onto the cart's truck/trailer via a conventional ramp.

Controlled movement of the welders' cart is important. First, the cart must have sufficient power in its driven wheel(s) to load itself and its carried engine, fuel tank, generator, hydraulic power system pump(s) and oil reservoir, wheel drives, welder, and tools up onto and down from, for example, pick-up truck beds or trailers via ramps. Depending on the height of the pick-up truck bed or trailer and the length of the ramp, the angle of the ramp may be steep, as much as about 40°, but more typically about 20° and less. Therefore, the loaded-for-work cart must have sufficient approach angle and departure angle to accommodate at least the possibly broad range of expected loading ramp incline or angle.

Also, for work in rougher terrain, for example, the loaded-for-work welders' cart must have sufficient ground clearance height. For example, for off-road use, with heavy duty tires on the wheels, the cart may have as much as about 24 inches of ground clearance, however, the clearance is more typically about 18 inches and less.

Besides ground clearance, the welders' off-road version of the cart must have sufficient breakover angle for convenient loading on steep ramps and for working in rougher terrain. Breakover angle is a result of clearance height and wheelbase length; the more the clearance height and/or the less the wheel-base length, the greater the breakover angle.

However, wheelbase length and clearance height for the welders' cart must, as for all vehicles, be carefully selected because their negative effect on the resulting center of gravity may result in the cart being “tippy” and unstable from relatively short wheelbase and high clearance in some embodiment(s). On the other hand, in other embodiment(s) of relatively long wheelbase and low clearance, the cart may be less “nimble” and less responsive to steering control, and more likely to be blocked by ground obstacles.

Also, the weight and centers of gravity of the cart's installed engine, fuel tank, generator, electric-over-hydraulic pumps and wheel drives, and electric/hydraulic valves and controllers, plus the location of welding hoses, electrical and/or gas lines and other welding supplies and tools, must be considered when designing and manufacturing the cart for maximum effectiveness and safety in expected environments.

Also, convenient and effective dimensions and weight of the welders' cart will be important. First, for transport, some embodiments of the cart preferably must conveniently fit, for example, within the bed of a standard-sized ½ ton-1 ton pick-up truck. Therefore, the outer dimensions of these embodiments of the cart in a top view should be about 6 feet long by 4 feet wide, and less. Smaller dimensions than these may be preferred due to less room in the pick-up truck bed, for example, from interior rear wheel wells and earlier-installed bed boxes in the front and/or side inside of the pick-up truck bed, for example. The overall height of the loaded-for-work cart must be less than local height restrictions for overhead bridges, expected garage and shop doorways and ceilings, and overhead power and communication lines, for example. Again, as for all loaded vehicles, safety considerations of the effect of the weight and center-of-gravity of the loaded-for-work cart, and their effect on the drivability and control of the carrying or towing pick-up truck and/or trailer are important.

Typically, the loaded-for-work cart for most steel fence construction will weigh less than about 1,000 pounds, preferably less than about 600 pounds. Also, from a design point-of-view, the wheel weight distribution of the loaded-for-work cart should be between about 60-40% on the drive track(s) or wheel(s) for one or two-wheel drive versions, and between about on all tracks(s) or wheels for 3-wheel or 4-wheel/track drive versions.

### BRIEF DESCRIPTION OF THE DRAWINGS

FIG. 1 is a schematic side right view of one embodiment of a track-driven welders' cart of the subject invention.

FIG. 2 is a schematic right-side view of the cart of FIG. 1, but without wheels or tracks.

FIG. 3 is a schematic right-side view of another cart embodiment of the subject invention that includes electric-hydraulic drive motors for the driven rear wheels and a steering system for the non-driven front wheels.

FIG. 4 is a schematic top view of the frame, rear wheel drive, and front wheel steering systems of the cart of FIG. 3, wherein the front and rear wheels comprise heavy duty tires.

FIG. 5 is a schematic depiction of one embodiment of the method of using the invented cart.

### DETAILED DESCRIPTION OF CERTAIN EMBODIMENTS

Referring to the Figures, there are shown several, but not all, embodiments of the invention.

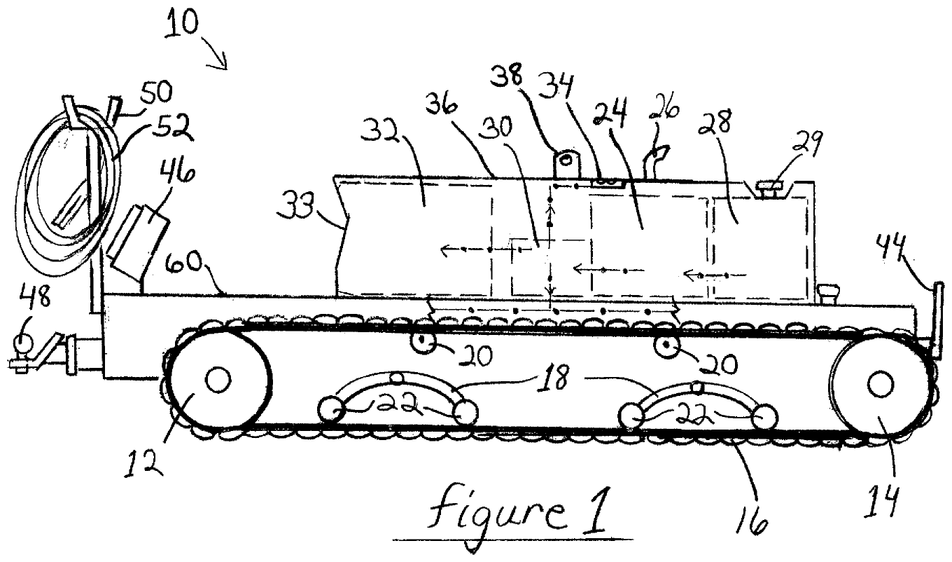

FIG. 1 depicts a schematic right-side view of one embodiment of a track-driven cart of the subject invention. In FIG. 1 is welders' cart 10 with rear drive wheel 12, front drive wheel 14, track 16, track suspension 18, top track idlers/rollers 20 and bottom track idlers/rollers 22. Onboard combustion engine 24, with exhaust pipe 26, may be a gasoline, diesel, natural gas, or LPG fueled engine, for example. The engine 24 receives fuel from fuel tank 28, which may be filled via filler pipe 29 with cap, and powers an on-board electric generator 30. The generator 30 powers the welder unit 32, an auxiliary power outlet 34, and other systems on the cart 10 as will be discussed below. Welder unit has welder face 33 that is visible and accessible to a user who stands at or near the rear end of the cart, which welder face 33 will be understood from commercial welders to comprise welding cable connections, controls, and operation gauges/indicators and instructions. Cart body 36 has lifting eye 38 and shrouds and protects the combustion engine 24, fuel tank 28, generator 30, and the welder unit 32. Cart 10 also has front bumper 44, a radio control relay 46 at the rear of the cart, a rear tow-hitch 48, and a rear stand 50 for holding welding cables/hoses 52 for storage or transport. All the elements described in this paragraph may be understood to be supported and connected and/or secured to the cart frame 60, so that the cart 10 may be transported, loaded, unloaded, driven, and used as a single unit that greatly increases convenience for a welder working in remote and rough terrains.

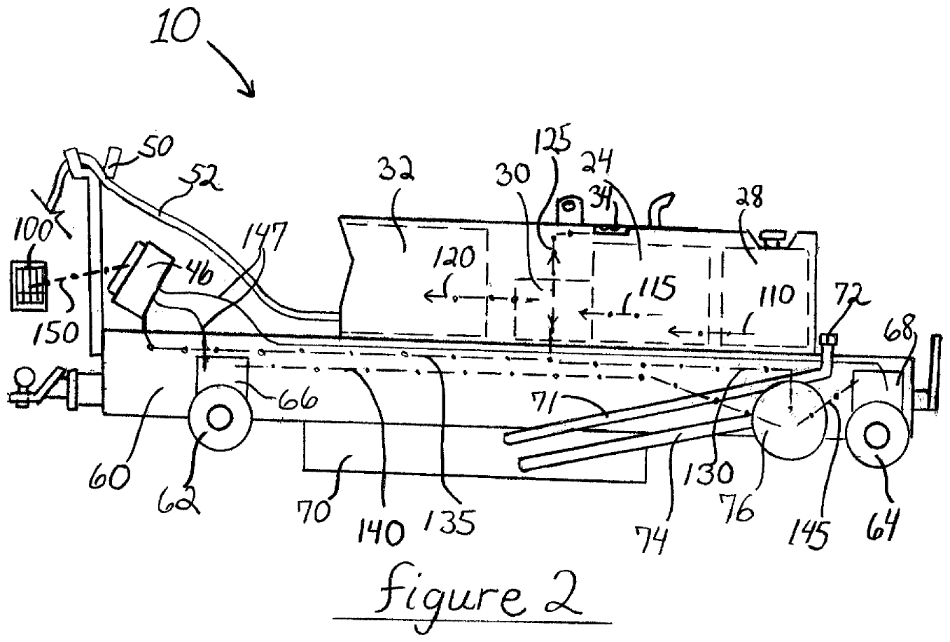

FIG. 2 depicts a schematic right-side view of the cart 10 of FIG. 1, with the tracks 16 and wheels 12, 14, and their associated equipment removed to show the frame 60, internally located elements secured to the frame 60 (and so described herein as being part of the cart frame), and electrical, fluid, or wireless communication between the elements. Cart frame 60 has rear wheel hydraulic drive motor 62, front wheel hydraulic drive motor 64, hydraulic valve bodies/units 66 and 68, and hydraulic oil tank 70. Hydraulic oil tank 70 may be filled via the filler tube 71 with opening and cap 72 accessible above the frame 60. Hydraulic oil flows via tank outlet 74 to the suction of the electric-driven hydraulic pump 76, which pumps/pressurizes the oil to flow to the hydraulic valve units 66, 68 controlling fluid flow to the hydraulic drive motors 62, 64. FIG. 2 also features a hand-held remote control 100 that wirelessly communicates with the control relay 46, wherein the remote control and control relay may be radio-wave based, that is, a radio-transmitting remote control and a radio-receiving relay or “radio control relay”. The radio control relay 46 in turn controls the functions and features of the cart 10, for example, electricity generation for the arc welder and electric-over-hydraulic pump 76, and the supply of hydraulic pressure/flow to the hydraulic valve units for powering the hydraulic wheel drive motors. Mechanical, electrical, and hydraulic connections/communication are schematically portrayed in the Figures as dash-dot-dash lines and will be understood from the drawings, this description, and knowledge of conventional electrical and hydraulic systems. For example, fuel flows 110 to the combustion engine 24, the combustion engine 24 powers a mechanical shaft 115 that generates electrical power in generator 30. That electricity powers the welder unit 32 at 120, the auxiliary outlet 34 at 125, the electric motor that drives the hydraulic pump 76 at 130, and the remote-control relay 46 at 135. Also, for example, pressurized hydraulic fluid from the hydraulic pump 76 flows to the hydraulic valve units 66, 68 at 140, and 145, and solenoids of the valve units are controlled at 147. It will be understood that the electrical and hydraulic connections/communications 120, 125, 130, 135, 140, and 145 are drawn as single dash-dot-dash lines for simplicity and clarity of the drawings, but will be understood by those of skill in the electrical and hydraulic fields to be electrical and hydraulic circuits. Control connection/communication 147 is drawn in a solid line in FIG. 2 to differentiate it from other connections/communications. The hand-held remote control 100 is shown in FIG. 2 as wirelessly communicating with the radio control relay 36, for example, by radio waves at 150. Also, note that the welder cables 52 have been operatively connected to the face 33 of the welder unit 32, and uncoiled and pulled out from the stand 50, for use by the welder operator several feet/yards from the cart 10.

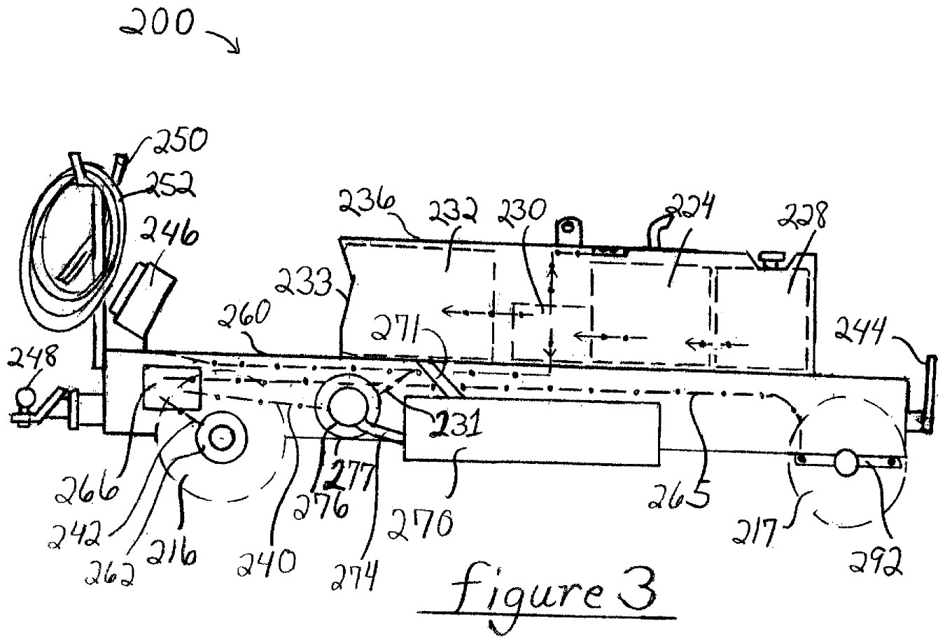

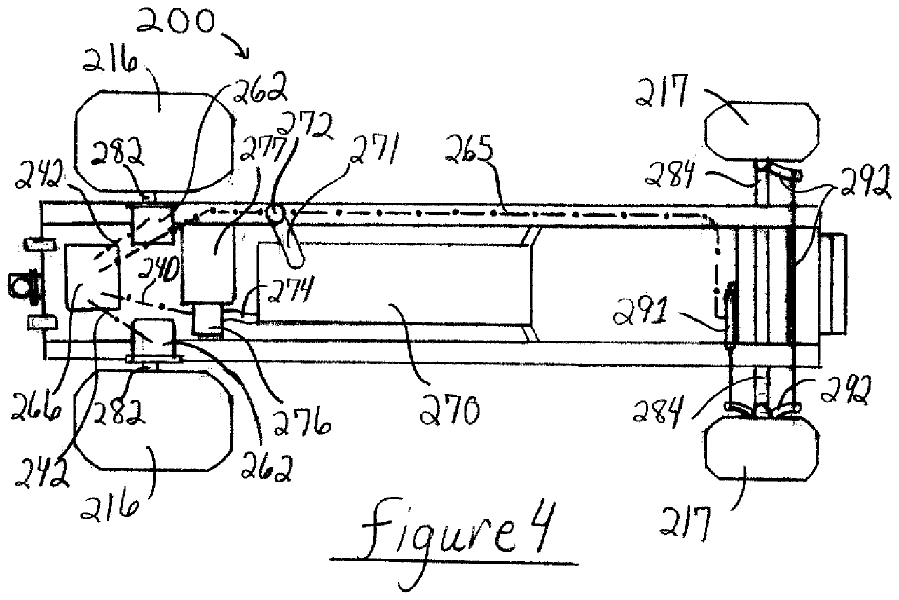

FIG. 3 depicts a schematic right-side view of an alternative embodiment, carat 200, having four heavy-duty tires 216, 217 shown in dashed lines to make certain internal cart parts more visible. FIG. 4 depicts a schematic top view of cart 200 in FIG. 3, but with the fuel tank 228, combustion engine 224, generator 230, welder 232, and cart body 236 removed to show certain underlaying parts. Cart 200 comprises many elements that are the same or similar to those of cart 10 and so are numbered as they are in cart 10 except adding 200, or not numbered in FIGS. 3 and 4 due to the viewer easily understanding the elements from the description of FIGS. 1 and 2. The mechanical and electrical connections/communications of the fuel tank 228, combustion engine 224, generator 230, welder 232, and electrical power supply to the radio control relay 246, may be the same as in cart 10 and so are not given reference numbers in FIG. 3 for simplicity.

Cart 200 features four wheels having heavy duty tires, including driven rear wheels/tires 216, and non-driven, steered front wheels/tires 217, operatively connected to the frame 260 by support and suspensions 282 and 284, respectively. Also, cart frame 260 supports and secures hydraulic oil tank 270 with tank outlet supply line 274, for pump 276, the suction of which is fed by line 274, and pressurized oil line 240 to hydraulic valve body 266 for the rear wheel and the front wheel steering system. Hydraulic valve body 266 directs pressurized hydraulic oil supply 242 to the hydraulic wheel drive motor 262 for rear wheels 216. As described above re the hydraulic system being a circuit even though the “return lines” are not drawn, it will be understood that the unpressurized oil returns to hydraulic oil tank 270. Makeup hydraulic oil is added via filler tube 271, with an opening/cap 272 visible in FIG. 4. Overall, electric motor 277, supplied with electricity at 231 from the generator 230, drives hydraulic pump 276. Also, pressurized hydraulic oil steering supply at 265 powers a steering control mechanism, which may be a rack and pinion system including a hydraulic piston 291 and tie rod system 292, again with unpressurized hydraulic steering oil return not separately shown but understood to be part of the hydraulic circuit.

It may be noted that an “electric-over-hydraulic pump” comprises an electrically powered motor that mechanically connects and drives a hydraulic fluid pump to provide high pressure hydraulic fluid, which in turn is delivered to hydraulic valve bodies. Thus, the combination of electric motor 277 and hydraulic pump 276 (shown to best advantage in FIG. 4) may be called an “electric-over-hydraulic pump”. Here, via the hydraulic valve bodies, hydraulic pressure is controlled and supplied to hydraulic wheel drive motor(s) connected to each wheel to be driven/powered. Thus, control of the wheel drive motors may be obtained via electrical signals on and off (147 in FIG. 2) to, for example, conventional solenoid-type valves on/in the hydraulic valve body 266. Also, control of a forward-reverse gear box and steering mechanisms may also be obtained via electrical signals in conventional manner to similar solenoid-type valves on hydraulic valve bodies.

For remote control, the electrical wires on the valve bodies may be energized on/off according to instructions received from the remote operator of the cart, via the hand-held remote control 100, at the radio control switching panel or “radio control relay 46, 246. Once positioned at the work site, as per the discussion above, the operator may then take manual control over welding system 32, 232, 52, 252. When a length of welding work has been completed and the welding cords and hoses of the welding system need to extend past their length to do more welding, then the above positioning process of the welders' cart may be repeated without the welder operator having to pack up and transport the welding system, via truck or other vehicle, to begin welding again at the new locations, as he/she would have to do in the prior art method.

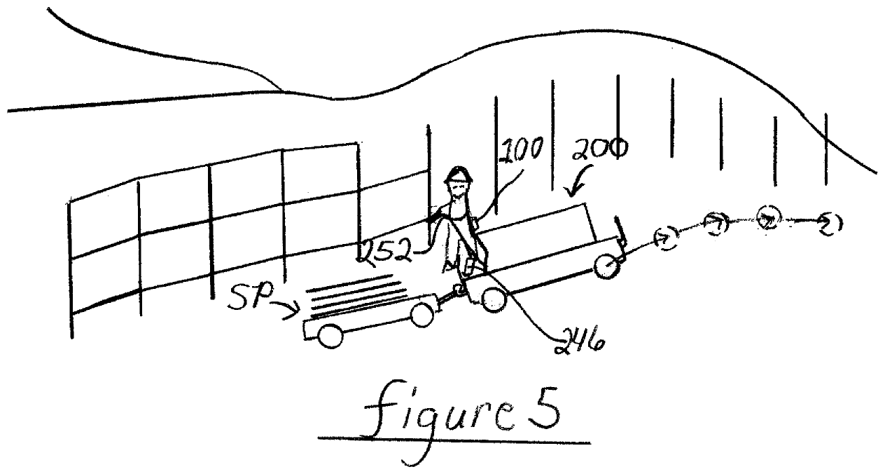

FIG. 5 is a schematic depiction of one embodiment of the method of using the invented cart. In FIG. 5, a welder/operator is using an embodiment of cart 200 in a remote area where he/she is building a metal fence requiring welding. The cart is separated and distanced from any truck or trailer that brought it to the general area of the work site. The welder/operator has remote-control driven the cart off that truck or trailer, hitched a wheeled supply platform SP to the back hitch of the cart, and has remote-control driven the cart towing the supply platform SP to the location of the fence-building. With the combustion engine and generator under the cart body operating to produce electricity and power for a hydraulic system and welding system on the cart, the welder has proceeded to build the fence. In FIG. 5, the welder/operator has pulled the welder machine cables and/or hoses to the fence portion being welded. When the next fence portion, to the right in the drawing, that is too far for the welder cables to reach from the parked cart, the welder/operator will remote-control the cart to advance to the right, as schematically shown by the arrows in “wheel circles”. The cart is powerful enough and has all-terrain tires capable of good traction, so that the cart can effectively pull the supply platform SP behind, even with the supply platform SP loaded with the fence parts needed for the project. This way, the welder/operator need not get in a pickup or other vehicle to advance a short distance, but instead may easily remote-drive the cart a few feet or yards at a time as needed, thus enhancing convenience and safety.

Therefore, in certain embodiments, the method for on-site creation of metal fences may be described as comprising: providing a portable welding machine on a movable welders' cart; the cart being made movable by a drive motor powered by a hydraulic pump on the cart; the hydraulic pump being driven by an electric motor powered by electricity from a generator driven by an internal combustion engine with a fuel tank, the electric motor, generator internal combustion engine, and fuel tank also being on the cart; movement of the cart being remotely controlled by a radio or other non-wired controller with the drive motor and a steering system also on the cart, so that, when a length of fence has been created to an extent that is about or equal to the welding machine's capability to weld for a certain length away from the cart, the cart may be remotely moved to enable additional welding at another location. The method may also comprise the welders' cart being constructed to fit within the box (back pick-up bed) of a conventional ½-ton to 1-ton pickup truck.

Although this disclosed technology has been described above with reference to particular means, materials, and embodiments, it is to be understood that the disclosed technology is not limited to these disclosed particulars but extends instead to all equivalents within the broad scope of this disclosure, including this description, the drawings, and the claims.

What is claimed is:

1. A welders' cart, comprising a cart frame supporting and securing an internal combustion engine with a fuel tank for the engine;
the internal combustion engine powering an electricity generator also supported and secured by the cart frame;
the electricity generator providing electricity for a portable welding machine also supported and secured by the cart frame;
the frame being supported by a set of tracks;
the frame being made mobile by a driven track;
the driven track being rotated by a hydraulic motor powered by electricity from the electricity generator on the cart;
the cart being made steerable by a steering track; and
the driven track and the steering track being remotely controllable by a radio or other non-wired remote controller.

2. The cart of claim 1 being supported by 2, 3, or 4 tracks.

3. The cart of claim 1 having 2, 3 or 4 driven tracks.

4. The cart of claim 1 being about 6 feet long, or less.

5. The cart of claim 1 being about 4 feet wide, or less.

6. The cart of claim 1 wherein the remote controller is not connected to the cart by any electrical or electronic cable or wire.

7. A welders' cart, comprising a cart frame supporting and securing an internal combustion engine with a fuel tank for the engine;
the internal combustion engine powering an electricity generator also supported and secured by the cart frame;
the electricity generator providing electricity for a portable welding machine also supported and secured by the cart frame;
the frame being supported by a set of wheels;
the frame being made mobile by a driven wheel;
the driven wheel being rotated by a hydraulic motor powered by electricity from the electricity generator on the cart;
the cart being made steerable by a steering wheel; and
the driven wheel and the steering wheel being remotely controllable by a radio or other non-wired remote controller.

8. The cart of claim 7 being supported by 3 or 4 wheels.

9. The cart of claim 7 having 2, 3 or 4 driven wheels.

10. The cart of claim 7 having 1, 2 or 4 steering wheels.

11. The cart of claim 7 being about 6 feet long, or less.

12. The cart of claim 7 being about 4 feet wide, or less.

13. The cart of claim 7 wherein the remote controller is not connected to the cart by any electrical or electronic cable or wire.

14. A method for on-site creation of metal fences, comprising:
providing a portable welding machine on a movable welders' cart, the welding machine having capability to weld for a certain length away from the fixed cart;
the cart being made movable by a drive motor powered by a hydraulic pump on the cart;
the hydraulic pump being driven by an electric motor powered by electricity from a generator driven by an internal combustion engine with a fuel tank, the electric motor,
generator internal combustion engine, and fuel tank also being on the cart;
movement of the cart being remotely controlled by a radio or other non-wired controller for the drive motor and a steering system also on the cart, so that, when a length of fence has been created to an extent about the welding machine's capability to weld for a certain length away from the fixed cart, the cart may be remotely moved to enable additional welding.

15. The method of claim 14 wherein the welders' cart is constructed to fit within the box of a conventional ½-1 ton pickup truck.
